(19) United States
(12) Patent Application Publication
(10) Pub. No.: US 2015/0139367 A1
(43) Pub. Date: May 21, 2015

(54) METHOD AND APPARATUS FOR ENHANCED CHANNEL ESTIMATION USING MATCHING PURSUIT AND ADAPTIVE CLUSTER TRACKING

(71) Applicant: QUALCOMM Incorporated, San Diego, CA (US)

(72) Inventors: Farrokh ABRISHAMKAR, San Diego, CA (US); Venkata Gautham Chavali, Hyderbad (IN); Insung Kang, San Diego, CA (US); Carlos Ruben Cabrera-Mercader, San Diego, CA (US); Hari Sankar, San Diego, CA (US); Aamod Dinkar Khandekar, San Diego, CA (US)

(73) Assignee: QUALCOMM Incorporated, San Diego, CA (US)

(21) Appl. No.: 14/082,877

(22) Filed: Nov. 18, 2013

(51) Int. Cl. H04L 25/02

(52) U.S. Cl. CPC H04L 25/0256
USPC 375/346

(57) ABSTRACT

Apparatus and methods for channel estimation include determining two streams corresponding to odd and even samples of a received signal that is sampled at a first chip rate, performing least squares successive interference cancellation on each of the two streams to obtain odd and even raw channel estimates, interlacing the odd and even raw channel estimates to obtain interlaced channel estimates, interpolating additional samples in the interlaced channel estimates to create higher chip rate channel estimates, identifying a first set of tap positions based on the higher chip rate channel estimates, applying matching pursuit to the first set of tap positions to identify a second set of tap positions, wherein the second set of tap positions includes fewer tap positions than the first set of tap positions, and determining a third set of tap positions by clustering each tap position included in the second set of tap positions.

### REFERENCE TO CO-PENDING APPLICATIONS FOR PATENT

The present application for Patent is related to the following co-pending U.S. patent applications:

“ENHANCED CHANNEL ESTIMATION IN TD-SCDMA,” having Attorney Docket No. 133050, filed concurrently herewith, assigned to the assignee hereof, and expressly incorporated by reference herein; and

“METHOD AND APPARATUS FOR ENHANCED CHANNEL ESTIMATION USING MATCHING PURSUIT,” having Attorney Docket No. 133064, filed concurrently herewith, assigned to the assignee hereof, and expressly incorporated by reference herein.

### BACKGROUND

Aspects of the present disclosure relate generally to wireless communication systems, and more particularly, to enhanced channel estimation using matching pursuit and adaptive cluster tracking.

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

Accurate channel estimation in Time Division Synchronous Code Division Multiple Access (TD-SCDMA) is critical for ensuring acceptable receive performance. Channel estimation impacts demodulation, decode cell reselection and much of TD-SCDMA protocol processing. As such, channel estimation is a key performance indicator for wireless communications. Accordingly, improvements in channel estimation may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, a method for channel estimation is provided that includes determining two streams corresponding to odd and even samples of a received signal that is sampled at a first chip rate, performing least squares successive interference cancellation on each of the two streams to obtain odd and even raw channel estimates, interlacing the odd and even raw channel estimates to obtain interlaced channel estimates, interpolating additional samples in the interlaced channel estimates to create higher chip rate channel estimates, identifying a first set of tap positions based on the higher chip rate channel estimates, applying matching pursuit to the first set of tap positions to identify a second set of tap positions, wherein the second set of tap positions includes fewer tap positions than the first set of tap positions, and determining a third set of tap positions by clustering each tap position included in the second set of tap positions.

In another aspect, an apparatus for channel estimation is provided that includes a processing system configured to determine two streams corresponding to odd and even samples of a received signal that is sampled at a first chip rate, perform least squares successive interference cancellation on each of the two streams to obtain odd and even raw channel estimates, interlace the odd and even raw channel estimates to obtain interlaced channel estimates, interpolate additional samples in the interlaced channel estimates to create higher chip rate channel estimates, identify a first set of tap positions based on the higher chip rate channel estimates, apply matching pursuit to the first set of tap positions to identify a second set of tap positions, wherein the second set of tap positions includes fewer tap positions than the first set of tap positions, and determine a third set of tap positions by clustering each tap position included in the second set of tap positions.

In a further aspect, a computer program product for channel estimation is provided that includes a computer-readable medium including code for determining two streams corresponding to odd and even samples of a received signal that is sampled at a first chip rate, code for performing least squares successive interference cancellation on each of the two streams to obtain odd and even raw channel estimates, code for interlacing the odd and even raw channel estimates to obtain interlaced channel estimates, code for interpolating additional samples in the interlaced channel estimates to create higher chip rate channel estimates, code for identifying a first set of tap positions based on the higher chip rate channel estimates, code for applying matching pursuit to the first set of tap positions to identify a second set of tap positions, wherein the second set of tap positions includes fewer tap positions than the first set of tap positions, and code for determining a third set of tap positions by clustering each tap position included in the second set of tap positions.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a wireless communications system, including a base station in communication with a user equipment configured to perform enhanced channel estimation using matching pursuit and adaptive cluster tracking;

FIG. 2 is a flow chart illustrating processes for performing enhanced channel estimation using matching pursuit and adaptive cluster tracking;

FIG. 3 is a flow chart illustrating processes for performing channel estimation, including the enhanced channel estimation processes of FIG. 2,

FIG. 4 is a flow chart illustrating a method for enhanced channel estimation using matching pursuit and adaptive cluster tracking;

FIG. 5 is a flow chart illustrating additional aspects of the method of FIG. 4;

FIG. 6 is a diagram of a hardware implementation for an apparatus employing a processing system and having aspects configured to perform enhanced channel estimation using matching pursuit and adaptive cluster tracking;

FIG. 7 is a diagram illustrating an example of a telecommunications system having aspects configured to perform enhanced channel estimation using matching pursuit and adaptive cluster tracking;

FIG. 8 is a diagram illustrating an example of a frame structure in a telecommunications system having aspects configured to perform enhanced channel estimation using matching pursuit and adaptive cluster tracking; and

FIG. 9 is a diagram illustrating an example of a Node B in communication with a UE in a telecommunications system having aspects configured to perform enhanced channel estimation using matching pursuit and adaptive cluster tracking.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Channel estimation may be enhanced at a user equipment (UE) operating in TD-SCDMA by exploiting the sparse nature of the TD-SCDMA propagation channel. In TD-SCDMA, symbols are three time longer than symbols in WCDMA. As such, the overall channel is much more sub-chip spaced. Such channels may be referred to as “fat path” channels. As such, sparse approximation methods may be used to hone a previously-identified number of likely channel taps that are packed together in sub-chip spacing intervals.

According to the present aspects, channel estimation may be enhanced by using matching pursuit (MP) and adaptive cluster tracking. More particularly, matching pursuit may be used to narrow down a number of previously-identified taps in order to provide a more accurate identification of non-zero tap positions. In an aspect, once the set of tap positions are identified by matching pursuit, an additional refining technique of adaptive cluster tracking, or cluster identification (or cluster ID) may be applied.

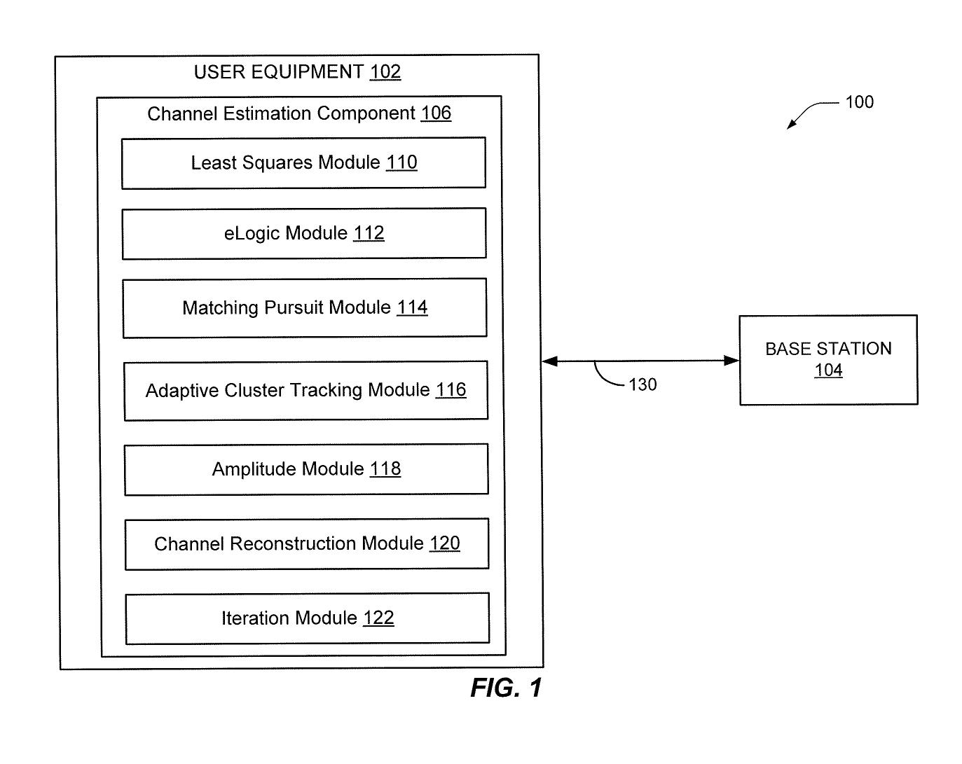

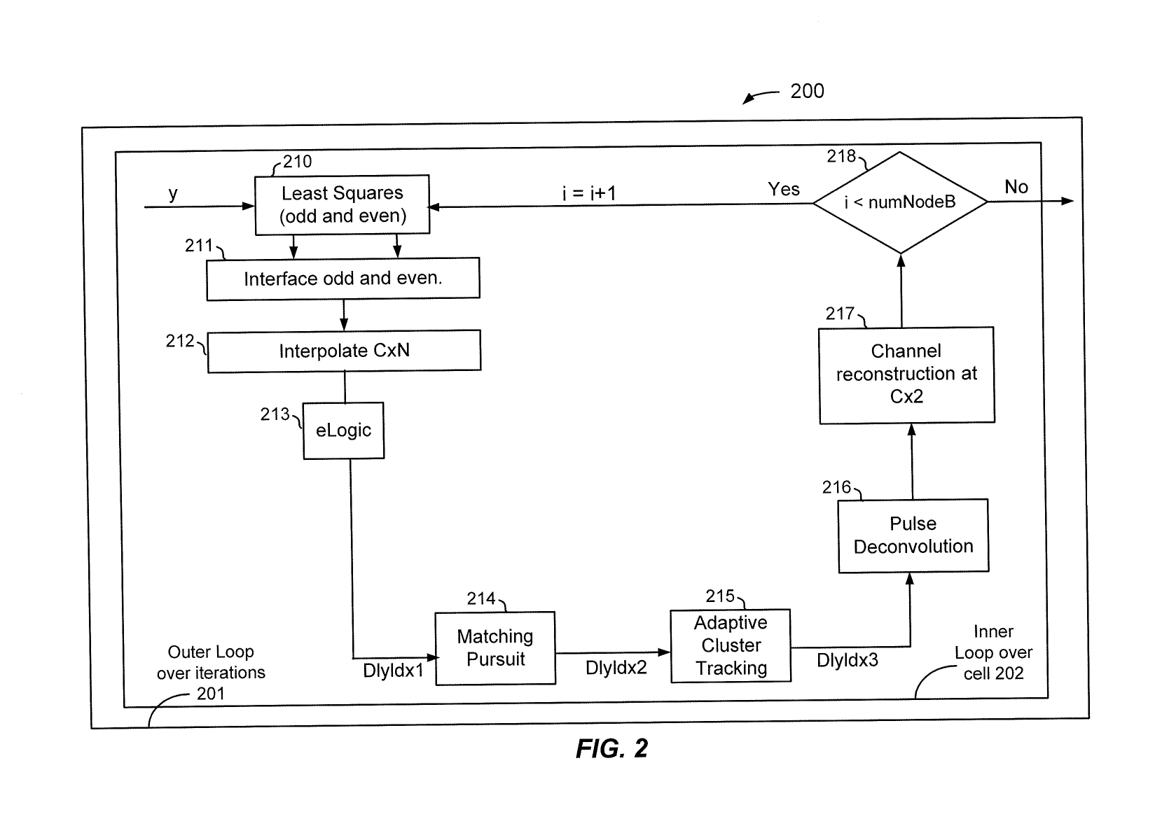

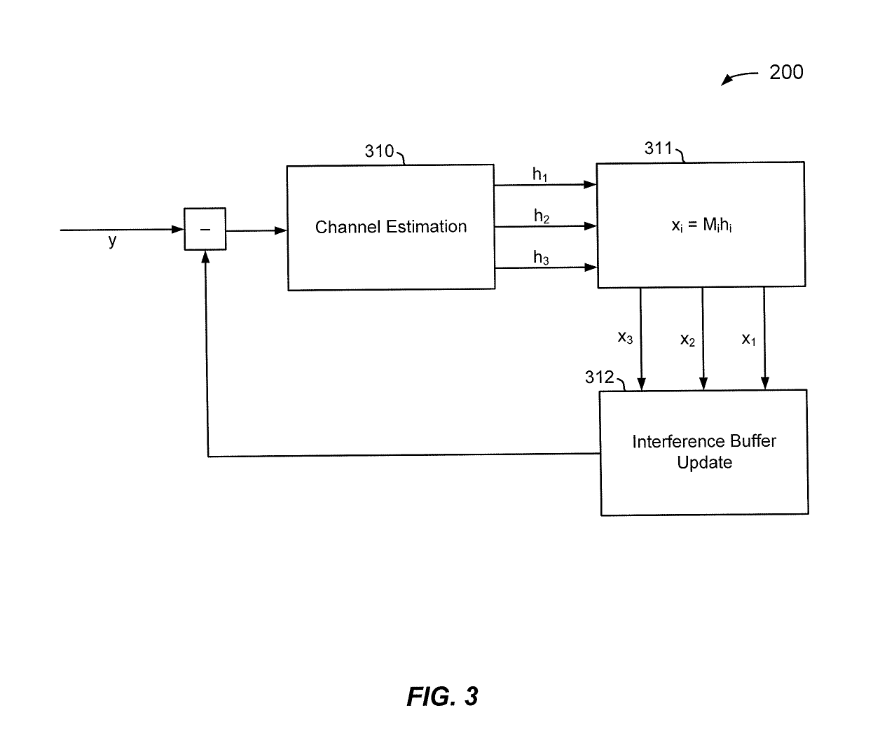

Referring to FIGS. 1, 2, and 3, a wireless communication system 100 includes a base station 104 in communication with a user equipment (UE) 102 configured to perform enhanced channel estimation 200 for a signal 130 using matching pursuit and adaptive cluster tracking according to the present aspects. The functions performed by the components of UE 102 may be part of enhanced channel estimation 200 of FIGS. 2 and 3.

Base station 104, which also may be referred to as an access point or node, may be a large cell (e.g., macrocell), small cell (e.g., picocell or femtocell), relay, Node B, mobile Node B, UE (e.g., communicating in peer-to-peer or ad-hoc mode with UE 102), or substantially any type of component that can communicate with UE 102 to provide wireless network access. UE 102 also may be referred to as a mobile apparatus, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

UE 102 includes channel estimation component 106 configured to perform enhanced channel estimation 200 of FIG. 2 using matching pursuit and adaptive cluster tracking according to the present aspects. Channel estimation component 106 includes least squares module 110, enhanced logic (also referred to as “eLogic”) module 112, matching pursuit module 114, adaptive cluster tracking module 116, amplitude module 118, and channel reconstruction module 120, which may be configured to communicate with one another and perform aspects of enhanced channel estimation.

Least squares module 110, at 210 of FIG. 2, may be configured to sample a channel signal (y) 130 at chipx2 (e.g., at twice the normal chip rate), split it into two chipx1 streams corresponding to the odd and even sample, and perform least squares successive interference cancellation on each of the odd and even streams to obtain raw estimates of the channel on each stream. Then, least squares module 110, at 211 of FIG. 2, also may be configured to interlace the odd and even streams and, at 212 of FIG. 2, interpolate additional samples such that the raw channel estimate now has a higher chip rate, such as, for example, chipx8 (e.g., at 8 times the normal chip rate). Least squares module 110 may be configured to provide the chipx8 sampled channel estimate to eLogic module 112.

Based on the chipx8 samples, eLogic module 112, at 213 of FIG. 2, may be configured to apply any sort of eLogic to identify the first set of present, non-zero tap positions. For example, if it is assumed that there are 128 possible taps, eLogic module 112 may be configured to narrow this number significantly to identify a first set of tap positions. In an aspect, the eLogic module 112 may be configured to perform aspects related to eLogic prior to the interlacing and interpolation. In a particular, non-limiting example, eLogic module 112 may identify present tap positions by exploiting the physics of taps across time, and on the recognition that taps are either uncorrelated across time or governed by correlated fading channel structure. Generally, a wireless channel is correlated in time while noise is uncorrelated. This property can be exploited by eLogic module 112 to identify the presence or absence of the taps. For example, in one aspect, correlation of an estimated channel tap may be computed over time. If the correlation is close to zero, the tap is identified as noise. If the correlation is relatively large, the tap is identified as an active tap.

In some aspects, eLogic module 112 may be configured to use tapwise minimum means square error (MMSE) to determine a first set of tap positions and use temporal correlation to determine a second set of tap positions. In these aspects, if a tap is shown as present in both the first and second sets, that tap is declared as a signal tap.

The result of the eLogic and interlacing and interpolation procedures—the first set of tap positions—may be referred to as DIyIdx1. As such, eLogic module 112 may be configured to provide the first set of tap positions, DIyIdx1, to matching pursuit module 114 for further refinement.

Matching pursuit module 114, at 214 of FIG. 2, may be configured to further narrow and hone the first set of tap positions determined by eLogic module 112 by applying matching pursuit to the first set of tap positions, DIyIdx1, to further improve the channel estimation. In general, matching pursuit describes a type of numerical technique that involves finding the “best matching” projections of multidimensional data onto an over-complete dictionary.

In particular, once the first set of tap positions are identified by eLogic module 112, matching pursuit module 114 may be configured to further refine the identified tap positions (e.g., tap positions may be determined more accurately) to ensure that all identified non-zero taps are actually present (e.g., above a threshold value, such that taps that are substantially zero are not being counted as non-zero taps). As such, matching pursuit module 114 may be configured to further refine the first set of tap positions to identify a second set of tap positions, which are much more likely to accurately identify the actual, present taps.

In an aspect, matching pursuit module 114 may be configured to identify the second set of tap positions, which may be referred to as I_{Nmax} taps, by solving the problem min ∥y−Rh∥, such that ∥h∥₀≦Nₘₐₓ, where y is the estimated channel after it has been processed by eLogic module 112, R is the pulse matrix, and h is the deconvolved channels. To solve the problem, matching pursuit module 114 may perform the following algorithm.

Initialize: r₀=y

For k=1:Nₘₐₓ

cₖ=arg max | [symbol] rₖ₋₁, Rⱼ [symbol] _{|}

Iₖ={Iₖ₋₁cₖ}

Rₖ=rₖ₋₁− [symbol] rₖ₋₁, Rcₖ [symbol] (Rcₖ/normsq (Rcₖ))

However, it may be understood that other algorithms may be used to identify the second set of taps, I_{Nmax}.

More particularly, matching pursuit module 114 may be configured to use an iterative process whereby, for each iteration, a number of taps may be assumed. The assumed number of taps for earlier iterations may be smaller than the assumed number of taps used for later iterations. Such assumptions may be used in order to, for example, ensure that incorrectly identified taps (e.g., taps that are identified as being present, but actually are not present) are not propagated throughout later iterations causing larger errors in the overall channel estimation process. As such, and in a non-limiting example, assuming a five-iteration process, no less than two taps may be assumed for a first iteration, and no more than 10 taps may be assumed for a last iteration. The iterations in between may be any integer between 2 and 10 (e.g., 2, 4, 6, 8, 10 or 3, 5, 7, 9, 10 or the like).

An example set of results of matching pursuit is shown in Table 1, where in the first iteration, two taps are assumed (and, as such, there are two tap positions identified), four taps are assumed for iteration two, six taps are assumed for iteration three, eight taps are assumed for iteration four, and 10 taps are assumed for iteration five.

TABLE 1
Example matching pursuit results

| Itera- | | | | | | | | | | |
|---|---|---|---|---|---|---|---|---|---|---|
| tion | Tap Positions Identified | | | | | | | | | |
| 1 | 146 | 134 | 0 | 0 | 0 | 0 | 0 | 0 | 0 | 0 |
| 2 | 129 | 140 | 124 | 135 | 0 | 0 | 0 | 0 | 0 | 0 |
| 3 | 128 | 141 | 121 | 76 | 147 | 135 | 0 | 0 | 0 | 0 |
| 4 | 128 | 141 | 78 | 123 | 93 | 151 | 136 | 118 | 0 | 0 |
| 5 | 128 | 141 | 78 | 121 | 96 | 150 | 114 | 133 | 72 | 87 |

Once the tap positions are identified by matching pursuit, matching pursuit module 114 may be configured to perform a merge protection process to remove any duplicate taps from the second set of tap positions. The result of the merge protection may be referred to as DIyIdx2. Matching pursuit module 114 may be configured to provide the second set of tap positions, DIyIdx2 to adaptive cluster tracking module 116 for further refinement.

Adaptive cluster tracking module 116, at 215 of FIG. 2, may be configured to further narrow and hone the second set of tap positions, DIyIdx2, determined by matching pursuit module 114 to further improve the channel estimation. In an aspect, once the second set of tap positions are identified by matching pursuit module 114, as described above, an additional refining technique of adaptive cluster tracking, or cluster identification (or cluster identification) may be applied by adaptive cluster tracking module 116. Ideally, every iteration of the processing performed by matching pursuit module 114 should produce the same tap position; however, in the field, this is not the case due to, for example, noise, matching pursuit error, additional convolution, and/or the like. As such, adaptive cluster tracking module 116 may apply adaptive cluster tracking to more accurately determine actual tap positions from the second set of tap positions identified by matching pursuit module 114.

More particularly, adaptive cluster tracking module 116 may determine clusters based on the second set of tap positions, DIyIdx2, determined by matching pursuit module 114. A cluster may be centered around a particular tap position (e.g., the tap positions identified during the last iteration by the matching pursuit) and may also include, in a non-limiting example, two tap positions to each of the left and right, referred to as “shoulder” tap positions. For example, for an identified tap position of 128, a cluster centered on 128 may include shoulder tap positions 126, 127, 128, 129, and 130. As such, and in this particular example, the lowest tap position in such a range is 126 and the highest tap position in such a range is 130.

Referring again to the non-limiting example results of Table 1, Table 2 shows the matching pursuit results with an example cluster centered around tap position 128 (as shown in the first tap slot of the fifth iteration) identified.

TABLE 2
Example clustered matching pursuit results

| Itera- | | | | | | | | | | |
|---|---|---|---|---|---|---|---|---|---|---|
| tion | Tap Positions Identified | | | | | | | | | |
| 1 | 146 | 134 | 0 | 0 | 0 | 0 | 0 | 0 | 0 | 0 |
| 2 | 129 | 140 | 124 | 135 | 0 | 0 | 0 | 0 | 0 | 0 |
| 3 | 128 | 141 | 121 | 76 | 147 | 135 | 0 | 0 | 0 | 0 |
| 4 | 128 | 141 | 78 | 123 | 93 | 151 | 136 | 118 | 0 | 0 |
| 5 | 128 | 141 | 78 | 121 | 96 | 150 | 114 | 133 | 72 | 87 |

Table 3 shows clusters that can be identified based on the matching pursuit results of the (e.g., second set of tap positions), including the cluster center, cluster range (e.g., tap positions that are included in the cluster—two to the left and two to the right of the center), actual cluster members (e.g., tap positions in the second set of tap positions that fall within the cluster range), and frequency (e.g., how many members are in the cluster).

TABLE 3
Cluster Frequency

| | | | | | | | | | | |
|---|---|---|---|---|---|---|---|---|---|---|
| Cluster | 128 | 141 | 78 | 121 | 96 | 150 | 114 | 133 | 72 | 87 |
| Center | | | | | | | | | | |
| Cluster | 126-131 | 139-143 | 76-80 | 119-123 | 94-98 | 148-152 | 112-116 | 131-135 | 70-74 | 85-89 |
| Range | | | | | | | | | | |
| Cluster | 129 | 140 | 76 | 121 | 96 | 151 | 114 | 134 | 72 | 87 |
| Members | 128 | 141 | 78 | 123 | | 150 | | 135 | | |
| | 128 | 141 | 78 | 121 | | | | 135 | | |
| | 128 | 141 | | | | | | 133 | | |
| Frequency | 4 | 4 | 3 | 3 | 1 | 2 | 1 | 4 | 1 | 1 |

In an aspect, clusters that have a frequency lower than a threshold, such as, in a non-limiting example, two cluster members, may be assumed by adaptive cluster tracking module 116 to be false positives and removed. In other words, and in this example, if less than two members are within a particular cluster, adaptive cluster tracking module 116 may be configured to remove the tap position associated with the cluster from the second set of tap positions. As such, and still referring to the non-limiting example of Tables 1-3, adaptive cluster tracking module 116 may produce final tap positions, which may be referred to as a third set of tap positions, that include, for example, 78, 121, 128, 133, 141, and 150. As such, six taps are determined to be present in this non-limiting example; however, of course there may be more or less than six taps present and/or determined to be present.

Adaptive cluster tracking module 116 may be configured to provide the third set of taps, which also may be referred to as DIyIdx3, to amplitude module 118.

Channel estimation typically includes a cleaning aspect and an amplitude aspect. The processes performed by least squares module 110, eLogic module 112, matching pursuit module 114, and/or adaptive cluster tracking module 116, at 210, 211, 212, 213, 214, and/or 215 of FIG. 2, may be part of the cleaning aspects performed by channel estimation component 106. Additionally, in some aspects, amplitude module 118, at 216 of FIG. 2, may be configured to perform the amplitude aspect of channel estimation component 106. More particularly, amplitude module 118 may be configured to determine an amplitude aspect of channel estimation by, for example, applying pulse deconvolution 216 to determine an amplitude of the signal for each identified tap position included in the third set of taps, identified by adaptive cluster tracking module 116. Amplitude module 118 may be configured to provide the determined amplitudes and, in an aspect, the third set of tap positions, to channel reconstruction module 120.

Channel reconstruction module 120, at 217 of FIG. 2, may be configured to reconstruct (e.g., deconvolve) the original channel signal after the pulse deconvolution process performed by amplitude module 118. For example, channel reconstruction module 120 may be configured to reconstruct the original channel signal by combining the third set of tap positions (e.g., the final set of tap positions) determined by adaptive cluster tracking module 116 and the amplitudes determined by amplitude module 118 for each identified tap position. Channel reconstruction module 120 also may be configured to return the channel to its normal chip-spacing, for example, the channel is reconstructed to chipx2 by selecting only every 4th sample or chipx1 by selecting only every 8th sample.

Referring specifically to FIG. 2, the least squares aspects (e.g., at 210, 211, and 212), cleaning aspects (e.g., eLogic 213, matching pursuit 214, and adaptive cluster tracking 215 processes), and amplitude aspects (e.g., pulse deconvolution at 216), along with channel reconstruction 217 may be repeated as a loop 202 over each cell (e.g., base station 104) within the wireless communication system 100 that is sending the signal to UE 102. This procedure may be referred to as inner loop 202. More particularly, upon completion of the channel reconstruction at 217, channel reconstruction module 120 may be configured to inform iteration module 122 that the inner loop 202 has been completed for a particular cell (e.g., base station 104). In response, and at 218, iteration module 122 may be configured to determine whether the particular cell is the (only or) last cell over which the channel estimation may be performed. If the particular cell is not the (only or) last cell (e.g., i<numNodeB, where i is the number of iterations and numNodeB is the number of cells for which channels may be estimated), then the iteration number (i) is increased by one and the processes of inner loop 202 may be repeated. However, if the particular cell is the (only or) last cell (e.g., i=numNodeB), inner loop 202 processing may be considered to be completed.

Upon exiting inner loop 202, e.g., the processing of inner loop 202 has been completed once for each cell, the full set of inner loops 202 (e.g., one inner loop 202 per cell) may be repeated again on a per-iteration basis. This loop may be referred to as outer loop 201. The number of iterations of outer loop 201 may be, in a non-limiting example, five iterations. However, some other number may be selected.

Once the processes associated with inner loop 202 are completed, additional aspects within outer loop 201 may be performed by channel estimation component 106 of FIG. 1 to complete the channel estimation. More particularly, once all of the inner loops 202 are completed (e.g., on a per-cell basis), the outer loop 201, may be completed for a number of iterations. In a non-limiting example, the outer loop is performed for five iterations.

Referring specifically to FIG. 3, further aspects of the operation of enhanced channel estimation 200 are illustrated. The channel (y) is provided to the channel estimation 310 which may perform the processes performed by least squares module 110, eLogic module 112, matching pursuit module 114, adaptive cluster tracking module 116, amplitude module 118, and/or channel reconstruction module 120, at 210, 211, 212, 213, 214, 215, 216, and 217 as described above with respect to FIGS. 1 and 2. That is, the output of channel estimation 310 may be the deconvolved (e.g., reconstructed) channels, identified as h₁, h₂, . . . hₙ, where n is the number of channels being estimated. At 311, the deconvolved channel information may be used to determine a channel output for each channel, identified as x₁, x₂, . . . xₙ, where, again, n is the number of channels being estimated, according to the formula: xᵢ=Mᵢhᵢ, where Mᵢ is the midamble for each of the channels 1, 2, . . . n. At 312, the channel outputs x₁, x₂, . . . xₙ, an interference buffer of UE 102 (not shown) is updated with the channel outputs, which may include, in an aspect, information about the taps that were identified as being present (e.g., non-zero). Accordingly, successive interference cancellation is performed at the input to channel estimation 310 by subtracting the interference buffer output from y. That is, to estimate the channel for the 1^{st} cell (e.g., h₁), the interference component corresponding to the other cells (e.g., x₂ and x₃) is subtracted from y, and then y is provided as input to channel estimation 310.

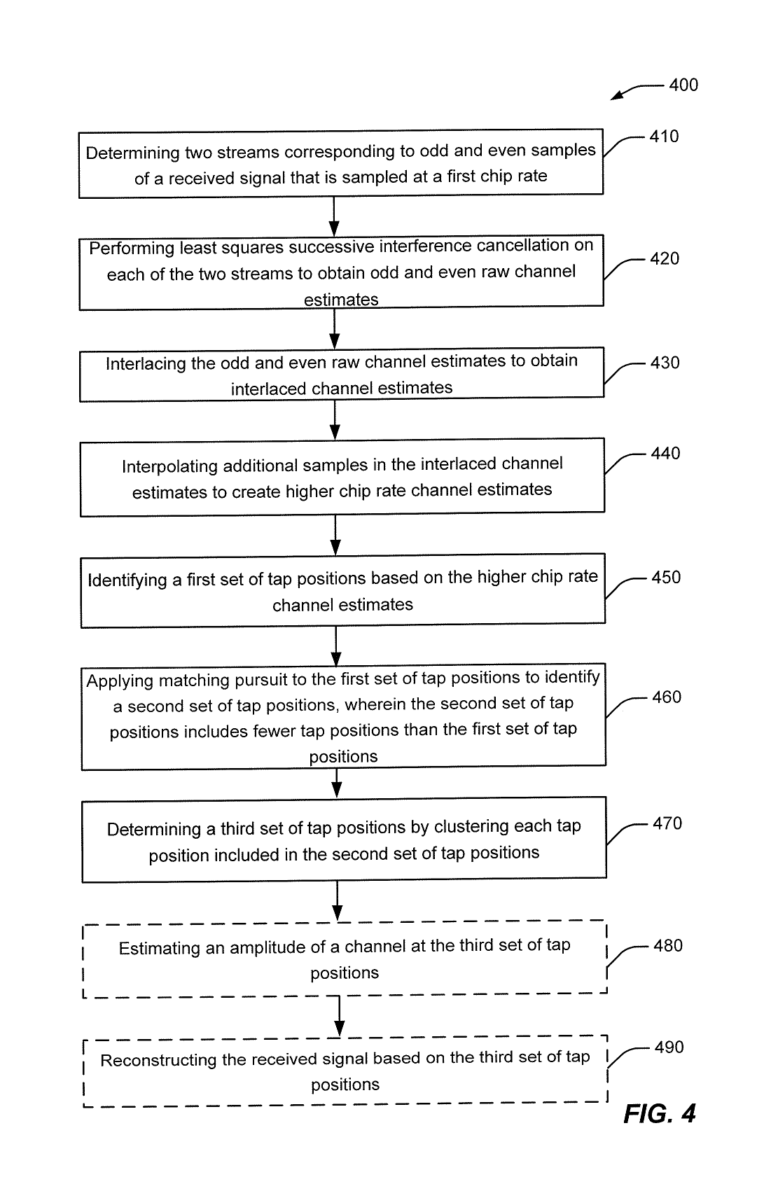

Referring to FIG. 4, a method 400 for enhanced channel estimation using matching pursuit and adaptive cluster tracking may be performed by channel estimation component 106 of UE 102 of FIG. 1. More particularly, least squares 110, eLogic module 112, matching pursuit module 114, adaptive cluster tracking module 116, amplitude module 118, channel reconstruction module 120, and/or iteration module 122 may be configured to perform aspects of method 400.

At 410, the method 400 includes determining two streams corresponding to odd and even samples of a received signal that is sampled at a first chip rate. For example, least squares module 110 of UE 102 may be configured to receive a signal 130 that is sampled at a first chip rate (e.g., at chipx2 or twice the normal chip rate) and determine two streams corresponding to odd and even samples of the received signal.

At 420, the method 400 includes performing least squares successive interference cancellation on each of the two streams to obtain odd and even raw channel estimates. For example, least squares module 110 may be further configured to perform least squares successive interference cancellation on each of the two streams to obtain odd and even raw channel estimates.

At 430, the method 400 includes interlacing the odd and even raw channel estimates to obtain interlaced channel estimates. For example, least squares module 110 may be further configured to interlace the odd and even raw channel estimates to obtain interlaced channel estimates.

At 440, the method 400 includes interpolating additional samples in the interlaced channel estimates to create higher chip rate channel estimates. For example, least squares module 110 may be configured to interpolate (e.g., create additional samples) in the interlaced channel estimates to create higher chip rate channel estimates, such as, for example, chipx8 (e.g., at 8 times the normal chip rate).

At 450, the method 400 includes identifying a first set of tap positions based on the higher chip rate channel estimates. For example, eLogic module 112 may be configured to identify a first set of tap positions (DIyIdx1) by performing enhanced logic (eLogic) on the higher chip rate signal (e.g., chipx8). In an aspect, the eLogic performed by eLogic module 112 may include one or both of tapwise MMSE and temporal correlation.

At 460, the method 400 includes applying matching pursuit to the first set of tap positions to identify a second set of tap positions, wherein the second set of tap positions includes fewer tap positions than the first set of tap positions. For example, matching pursuit module 114 may be configured to apply matching pursuit to the first set of tap positions to identify a second set of tap positions (DIyIdx2). The second set of tap positions may include fewer tap positions than the first set of tap positions. In an aspect, matching pursuit module 114 may be configured to identify a set of potential tap positions based on the first set of tap positions (DIyIdx1), and remove duplicate tap positions from the set of potential tap positions to create the second set of tap positions (DIyIdx2).

At 470, the method 400 includes determining a third set of tap positions by clustering each tap position included in the second set of tap positions. For example, adaptive cluster tracking module 116 may be configured to determine a third set of tap positions (DIyIdx3) by clustering each tap position included in the second set of tap positions (DIyIdx2).

Optionally, at 480, the method 400 includes estimating an amplitude of the channel at the third set of tap positions. For example, amplitude module 118 may be configured to determine an amplitude aspect of channel estimation by, for example, applying pulse deconvolution 216 (FIG. 2) to determine an amplitude of the signal for each identified tap position (DIyIdx3) included in the third set of tap positions, identified by adaptive cluster tracking module 116.

Optionally, at 490, the method 400 includes reconstructing the received signal based on the third set of tap positions. For example, channel reconstruction module 120 may be configured to reconstruct the signal based on the third set of tap positions (DIyIdx3). In an aspect, channel reconstruction module 120 may be configured to perform the reconstructing by sampling the third number of taps (DIyIdx3) at a third chip rate, which is twice the first chip rate (e.g., chipx2).

In an optional aspect (not shown), the method 400 may include determining an amplitude associated with each of the tap positions included in the third set of tap positions. For example, amplitude module 118 may be configured to determine an amplitude associated with each of the tap positions included in the third set of tap positions (DIyIdx3). In an aspect, channel reconstruction module 120 may be configured to combine the third set of tap positions (DIyIdx3) with amplitudes determined by amplitude module 118 to create a reconstructed signal, and sample the reconstructed signal according to a reduced chip rate.

In an optional aspect (not shown), the method 400 may include determining a number of cells associated with the channel estimation, and repeating the enhanced channel estimation processes for each cell and over a number of iterations. For example, iteration module 122 may be configured to determine a number of cells associated with the channel estimation, and repeat the actions of inner loop 202 for each cell and for outer loop 201 over a number of iterations. In an aspect, and a non-limiting example, the number of iterations may be five.

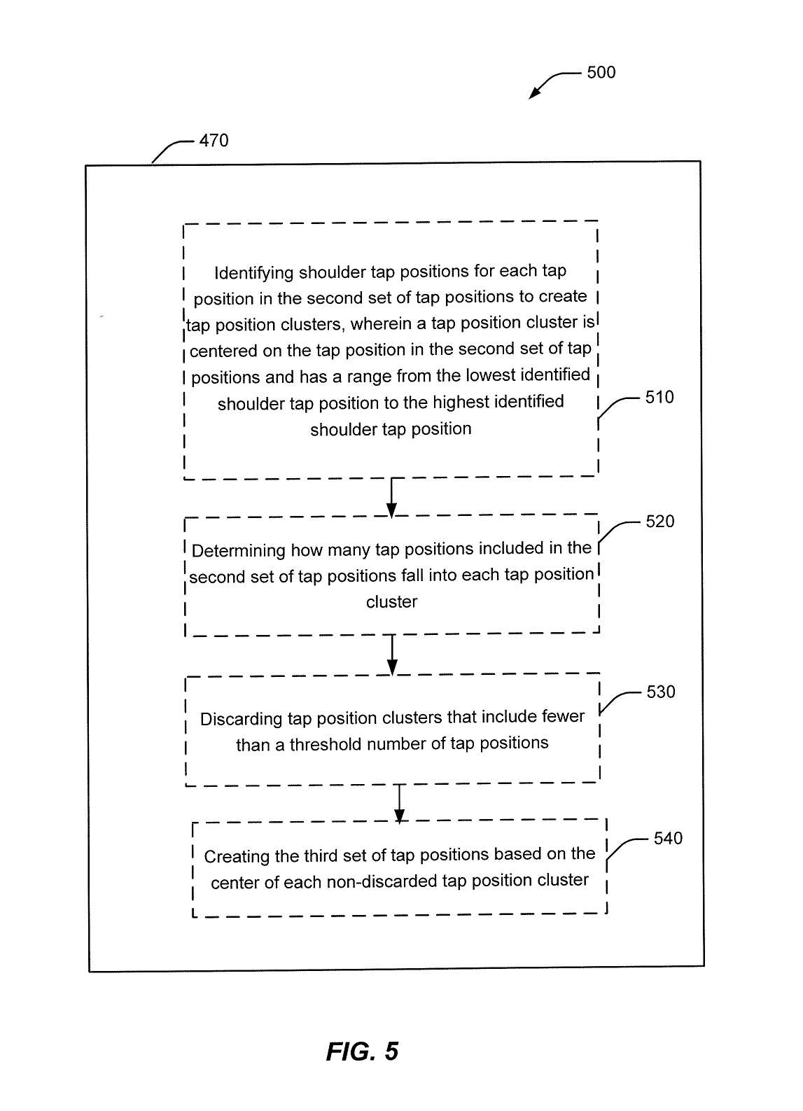

Referring to FIG. 5, a method 500 includes further, and optional, aspects related to method 400 of FIG. 4 for enhanced channel estimation using matching pursuit and adaptive cluster tracking. The aspects of method 500 may be performed by channel estimation component 106 of UE 102 of FIG. 1. More particularly, adaptive cluster tracking module 116 may be configured to perform further aspects of 470 of method 400 to determine the third set of tap positions by clustering each tap position included in the second set of tap positions.

At 510, the method 500 includes identifying shoulder tap positions for each tap position in the second set of tap positions to create tap position clusters, wherein a tap position cluster is centered on the tap position in the second set of tap positions and has a range from the lowest identified shoulder tap position to the highest identified shoulder tap position. For example, adaptive cluster tracking module 116 may be configured to identify shoulder tap positions for each tap position in the second set of tap positions (DIyIdx2) to create tap position clusters. In an aspect, a tap position cluster may be centered on the tap position in the second set of tap positions (DIyIdx2) and has a range from the lowest identified shoulder tap position to the highest identified shoulder tap position. In an aspect, adaptive cluster tracking module 116 may be configured to identify shoulder tap positions by identifying two tap positions to the left and two tap positions to the right of each tap position center.

At 520, the method 500 includes determining how many tap positions included in the second set of tap positions fall into each tap position cluster. For example, adaptive cluster tracking module 116 may be configured to determine how many tap positions included in the second set of tap positions (DIyIdx2) fall into each tap position cluster.

At 530, the method 500 includes discarding tap position clusters that include fewer than a threshold number of tap positions. For example, adaptive cluster tracking module 116 may be configured to discard tap position clusters that include fewer than a threshold number of tap positions. In an aspect, the threshold number of tap positions is two.

At 540, the method 500 includes creating the third set of tap positions based on the center of each non-discarded tap position cluster. For example, adaptive cluster tracking module 116 may be configured to create the third set of tap positions (DIyIdx3) based on the center of each non-discarded tap position cluster.

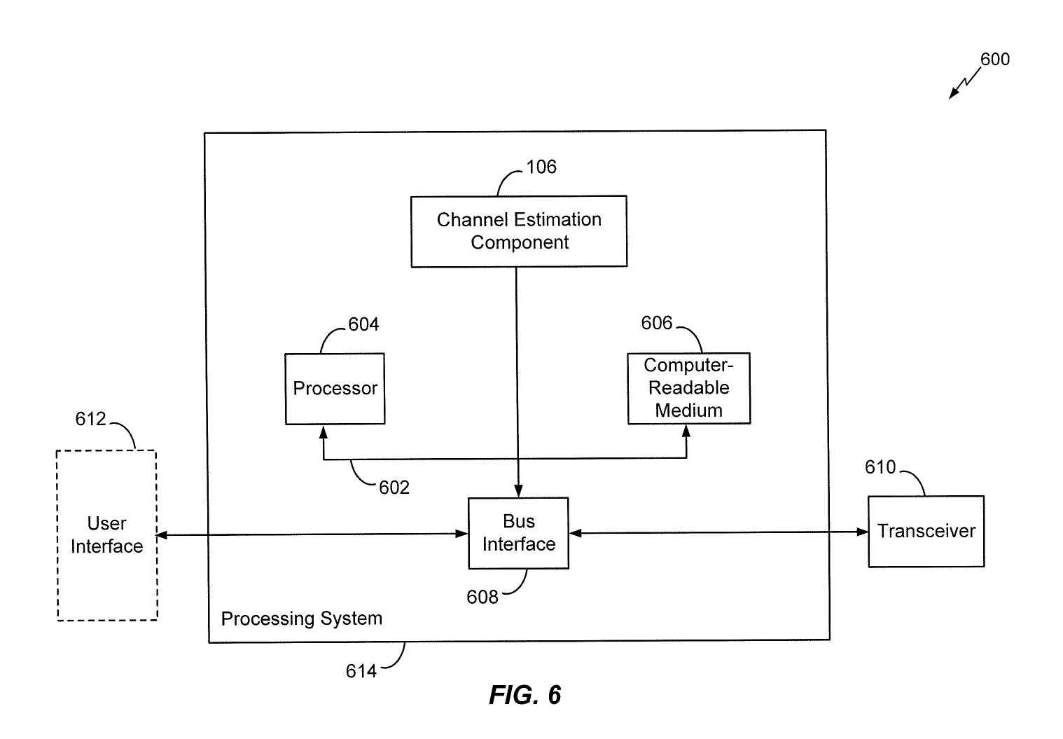

Referring to FIG. 6, an example of a hardware implementation for an apparatus 600 employing a processing system 614 having aspects configured for enhanced channel estimation using matching pursuit and adaptive cluster tracking is shown. In an aspect, apparatus 600 may be UE 102 of FIG. 1, including channel estimation component 106, which itself includes least squares module 110, eLogic module 112, matching pursuit module 114, adaptive cluster tracking module 116, amplitude module 118, channel reconstruction module 120, and iteration module 122.

In this example, the processing system 614 may be implemented with a bus architecture, represented generally by the bus 602. The bus 602 may include any number of interconnecting buses and bridges depending on the specific application of the processing system 614 and the overall design constraints. The bus 602 links together various circuits including one or more processors, represented generally by the processor 604, one or more communications components, such as, for example, channel estimation component 106 of FIG. 1, and computer-readable media, represented generally by the computer-readable medium 606. The bus 602 may also link various other circuits such as timing sources, peripherals, voltage regulators, and power management circuits, which are well known in the art, and therefore, will not be described any further. A bus interface 608 provides an interface between the bus 602 and a transceiver 610. The transceiver 610 provides a means for communicating with various other apparatus over a transmission medium. Depending upon the nature of the apparatus, a user interface 612 (e.g., keypad, display, speaker, microphone, joystick) may also be provided.

The processor 604 is responsible for managing the bus 602 and general processing, including the execution of software stored on the computer-readable medium 606. The software, when executed by the processor 604, causes the processing system 614 to perform the various functions described herein for any particular apparatus. More particularly, and as described above with respect to FIG. 1, channel estimation component 106, least squares module 110, eLogic module 112, matching pursuit module 114, adaptive cluster tracking module 116, amplitude module 118, channel reconstruction module 120, and/or iteration module 122 may be software components (e.g., software modules), such that the functionality described with respect to each of the modules may be performed by processor 604.

The computer-readable medium 606 may also be used for storing data that is manipulated by the processor 604 when executing software, such as, for example, software modules represented by channel estimation component 106, least squares module 110, eLogic module 112, matching pursuit module 114, adaptive cluster tracking module 116, amplitude module 118, channel reconstruction module 120, and/or iteration module 122. In one example, the software modules (e.g., any algorithms or functions that may be executed by processor 604 to perform the described functionality) and/or data used therewith (e.g., inputs, parameters, variables, and/or the like) may be retrieved from computer-readable medium 606.

More particularly, the processing system further includes at least one of channel estimation component 106, least squares module 110, eLogic module 112, matching pursuit module 114, adaptive cluster tracking module 116, amplitude module 118, channel reconstruction module 120, and/or iteration module 122. The modules may be software modules running in the processor 604, resident and/or stored in the computer-readable medium 606, one or more hardware modules coupled to the processor 604, or some combination thereof.

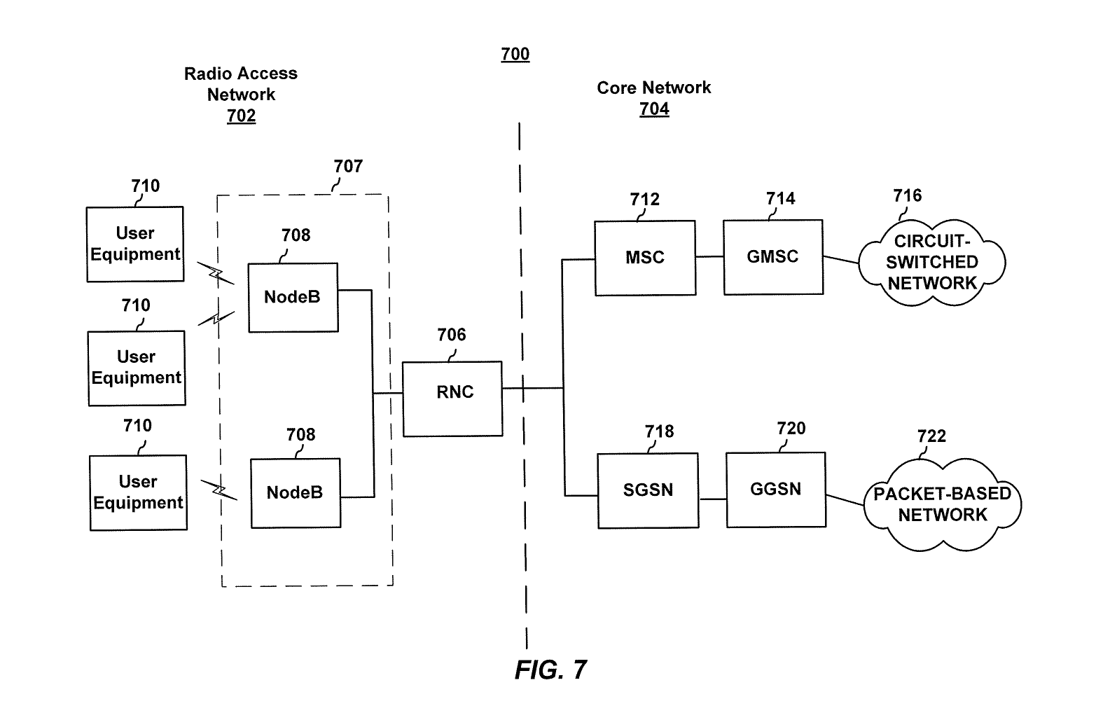

Turning now to FIG. 7, a block diagram is shown illustrating an example of a telecommunications system 700 having aspects configured for enhanced channel estimation using matching pursuit and adaptive cluster tracking. The various concepts presented throughout this disclosure may be implemented across a broad variety of telecommunication systems, network architectures, and communication standards. By way of example and without limitation, the aspects of the present disclosure illustrated in FIG. 7 are presented with reference to a UMTS system employing a TD-SCDMA standard. In this example, the UMTS system includes a (radio access network) RAN 702 (e.g., UTRAN) that provides various wireless services including telephony, video, data, messaging, broadcasts, and/or other services. The RAN 702 may be divided into a number of Radio Network Subsystems (RNSs) such as an RNS 707, each controlled by a Radio Network Controller (RNC) such as an RNC 706. For clarity, only the RNC 706 and the RNS 707 are shown; however, the RAN 702 may include any number of RNCs and RNSs in addition to the RNC 706 and RNS 707. The RNC 706 is an apparatus responsible for, among other things, assigning, reconfiguring and releasing radio resources within the RNS 707. The RNC 706 may be interconnected to other RNCs (not shown) in the RAN 702 through various types of interfaces such as a direct physical connection, a virtual network, or the like, using any suitable transport network.

The geographic region covered by the RNS 707 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 708 are shown; however, the RNS 707 may include any number of wireless Node Bs. The Node Bs 708 provide wireless access points to a core network 704 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 710, which may be the same as or similar to UE 102 of FIG. 1, are shown in communication with the Node Bs 708, which may be the same as or similar to base station 104 of FIG. 1. The downlink (DL), also called the forward link, refers to the communication link from a Node B to a UE, and the uplink (UL), also called the reverse link, refers to the communication link from a UE to a Node B.

The core network 704, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 704 supports circuit-switched services with a mobile switching center (MSC) 712 and a gateway MSC (GMSC) 714. One or more RNCs, such as the RNC 706, may be connected to the MSC 712. The MSC 712 is an apparatus that controls call setup, call routing, and UE mobility functions. The MSC 712 also includes a visitor location register (VLR) (not shown) that contains subscriber-related information for the duration that a UE is in the coverage area of the MSC 712. The GMSC 714 provides a gateway through the MSC 712 for the UE to access a circuit-switched network 716. The GMSC 714 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 714 queries the HLR to determine the UE's location and forwards the call to the particular MSC serving that location.

The core network 704 also supports packet-data services with a serving GPRS support node (SGSN) 718 and a gateway GPRS support node (GGSN) 720. GPRS, which stands for General Packet Radio Service, is designed to provide packet-data services at speeds higher than those available with standard GSM circuit-switched data services. The GGSN 720 provides a connection for the RAN 702 to a packet-based network 722. The packet-based network 722 may be the Internet, a private data network, or some other suitable packet-based network. The primary function of the GGSN 720 is to provide the UEs 710 with packet-based network connectivity. Data packets are transferred between the GGSN 720 and the UEs 710 through the SGSN 718, which performs primarily the same functions in the packet-based domain as the MSC 712 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 708 and a UE 710, but divides uplink and downlink transmissions into different time slots in the carrier.

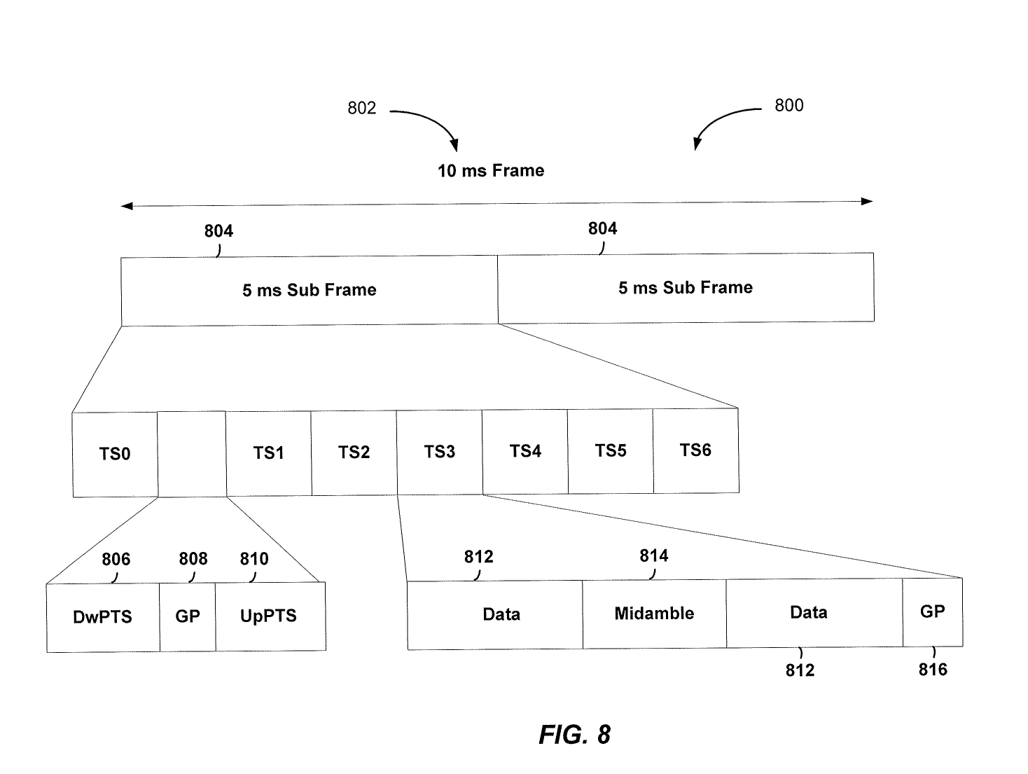

FIG. 8 shows a frame structure 800 for a TD-SCDMA carrier, which may be used for communications between base station 104 of FIG. 1, and UE 102, also of FIG. 1, having aspects configured for enhanced channel estimation using matching pursuit and adaptive cluster tracking. The TD-SCDMA carrier, as illustrated, has a frame 802 that is 10 ms in length. The frame 802 has two 5 ms subframes 804, and each of the subframes 804 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 806, a guard period (GP) 808, and an uplink pilot time slot (UpPTS) 810 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 812 separated by a midamble 814 and followed by a guard period (GP) 816. The midamble 814 may be used for features, such as channel estimation, while the GP 816 may be used to avoid inter-burst interference.

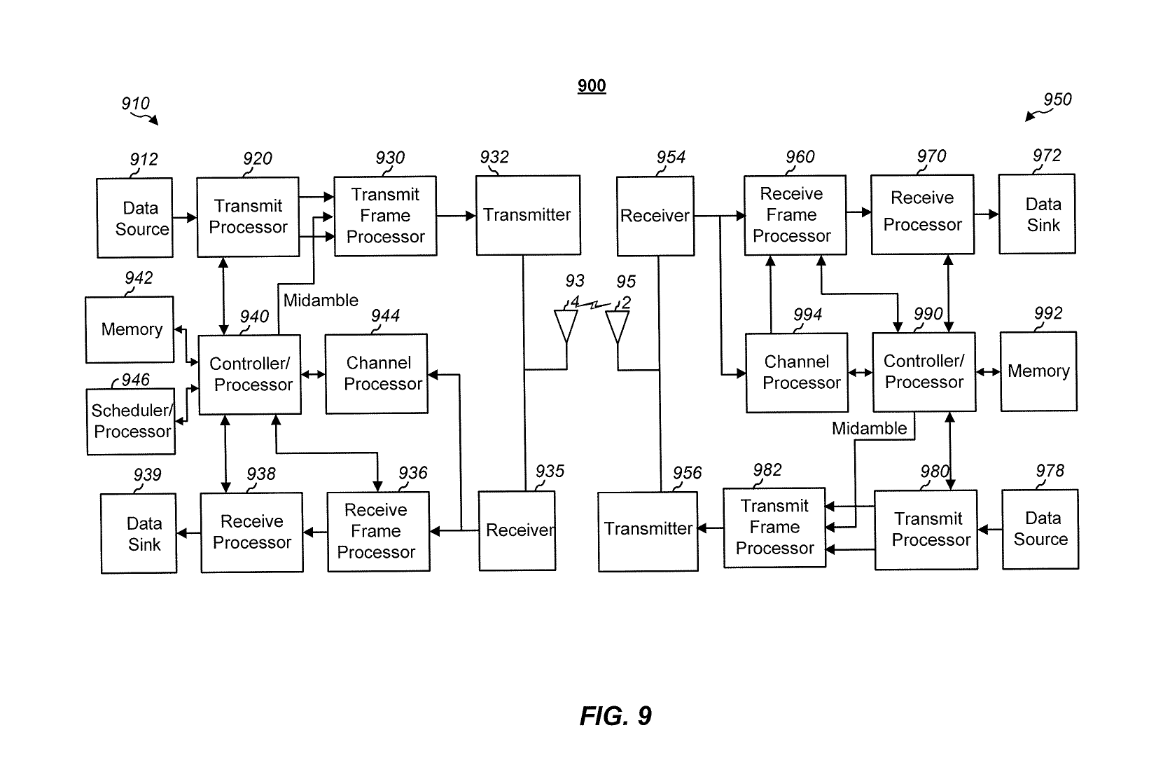

FIG. 9 is a block diagram of a Node B 910 in communication with a UE 950 in a RAN 900 having aspects configured for enhanced channel estimation using matching pursuit and adaptive cluster tracking. In an aspect, the RAN 900 may be the RAN 702 in FIG. 7, the Node B 910 may be the Node B 708 in FIG. 7 and/or base station 104 of FIG. 1, and the UE 950 may be the UE 710 in FIG. 7 and/or UE 102 of FIG. 1.

In the downlink communication, a transmit processor 920 may receive data from a data source 912 and control signals from a controller/processor 940. The transmit processor 920 provides various signal processing functions for the data and control signals, as well as reference signals (e.g., pilot signals). For example, the transmit processor 920 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 944 may be used by a controller/processor 940 to determine the coding, modulation, spreading, and/or scrambling schemes for the transmit processor 920. These channel estimates may be derived from a reference signal transmitted by the UE 950 or from feedback contained in the midamble 814 (FIG. 8) from the UE 950. The symbols generated by the transmit processor 920 are provided to a transmit frame processor 930 to create a frame structure. The transmit frame processor 930 creates this frame structure by multiplexing the symbols with a midamble 814 (FIG. 8) from the controller/processor 940, resulting in a series of frames. The frames are then provided to a transmitter 932, which provides various signal conditioning functions including amplifying, filtering, and modulating the frames onto a carrier for downlink transmission over the wireless medium through smart antennas 934. The smart antennas 934 may be implemented with beam steering bidirectional adaptive antenna arrays or other similar beam technologies.

At the UE 950, a receiver 954 receives the downlink transmission through an antenna 952 and processes the transmission to recover the information modulated onto the carrier. The information recovered by the receiver 954 is provided to a receive frame processor 960, which parses each frame, and provides the midamble 814 (FIG. 8) to a channel processor 994 and the data, control, and reference signals to a receive processor 970. The receive processor 970 then performs the inverse of the processing performed by the transmit processor 920 in the Node B 910. More specifically, the receive processor 970 descrambles and despreads the symbols, and then determines the most likely signal constellation points transmitted by the Node B 910 based on the modulation scheme. These soft decisions may be based on channel estimates computed by the channel processor 994. The soft decisions are then decoded and deinterleaved to recover the data, control, and reference signals. The CRC codes are then checked to determine whether the frames were successfully decoded. The data carried by the successfully decoded frames will then be provided to a data sink 972, which represents applications running in the UE 950 and/or various user interfaces (e.g., display). Control signals carried by successfully decoded frames will be provided to a controller/processor 990. When frames are unsuccessfully decoded by the receiver processor 970, the controller/processor 990 may also use an acknowledgement (ACK) and/or negative acknowledgement (NACK) protocol to support retransmission requests for those frames.

In the uplink, data from a data source 978 and control signals from the controller/processor 990 are provided to a transmit processor 980. The data source 978 may represent applications running in the UE 950 and various user interfaces (e.g., keyboard). Similar to the functionality described in connection with the downlink transmission by the Node B 910, the transmit processor 980 provides various signal processing functions including CRC codes, coding and interleaving to facilitate FEC, mapping to signal constellations, spreading with OVSFs, and scrambling to produce a series of symbols. Channel estimates, derived by the channel processor 994 from a reference signal transmitted by the Node B 910 or from feedback contained in the midamble transmitted by the Node B 910, may be used to select the appropriate coding, modulation, spreading, and/or scrambling schemes. The symbols produced by the transmit processor 980 will be provided to a transmit frame processor 982 to create a frame structure. The transmit frame processor 982 creates this frame structure by multiplexing the symbols with a midamble 814 (FIG. 8) from the controller/processor 990, resulting in a series of frames. The frames are then provided to a transmitter 956, which provides various signal conditioning functions including amplification, filtering, and modulating the frames onto a carrier for uplink transmission over the wireless medium through the antenna 952.

The uplink transmission is processed at the Node B 910 in a manner similar to that described in connection with the receiver function at the UE 950. A receiver 935 receives the uplink transmission through the antenna 934 and processes the transmission to recover the information modulated onto the carrier. The information recovered by the receiver 935 is provided to a receive frame processor 936, which parses each frame, and provides the midamble 814 (FIG. 8) to the channel processor 944 and the data, control, and reference signals to a receive processor 938. The receive processor 938 performs the inverse of the processing performed by the transmit processor 980 in the UE 950. The data and control signals carried by the successfully decoded frames may then be provided to a data sink 939 and the controller/processor, respectively. If some of the frames were unsuccessfully decoded by the receive processor, the controller/processor 940 may also use an acknowledgement (ACK) and/or negative acknowledgement (NACK) protocol to support retransmission requests for those frames.

The controller/processors 940 and 990 may be used to direct the operation at the Node B 910 and the UE 950, respectively. For example, the controller/processors 940 and 990 may provide various functions including timing, peripheral interfaces, voltage regulation, power management, and other control functions. The computer readable media of memories 942 and 992 may store data and software for the Node B 910 and the UE 950, respectively. A scheduler/processor 946 at the Node B 910 may be used to allocate resources to the UEs and schedule downlink and/or uplink transmissions for the UEs.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for channel estimation, comprising:
determining two streams corresponding to odd and even samples of a received signal that is sampled at a first chip rate;
performing least squares successive interference cancellation on each of the two streams to obtain odd and even raw channel estimates;
interlacing the odd and even raw channel estimates to obtain interlaced channel estimates;
interpolating additional samples in the interlaced channel estimates to create higher chip rate channel estimates;
identifying a first set of tap positions based on the higher chip rate channel estimates;
applying matching pursuit to the first set of tap positions to identify a second set of tap positions, wherein the second set of tap positions includes fewer tap positions than the first set of tap positions; and
determining a third set of tap positions by clustering each tap position included in the second set of tap positions.

2. The method of claim 1, further comprising:
estimating an amplitude of a channel at the third set of tap positions; and
reconstructing the received signal based on the third set of tap positions.

3. The method of claim 1, wherein determining the third set of tap positions by clustering each tap position included in the second set of tap positions comprises:
identifying shoulder tap positions for each tap position in the second set of tap positions to create tap position clusters, wherein a tap position cluster is centered on the tap position in the second set of tap positions and has a range from the lowest identified shoulder tap position to the highest identified shoulder tap position;
determining how many tap positions included in the second set of tap positions fall into each tap position cluster;
discarding tap position clusters that include fewer than a threshold number of tap positions; and
creating the third set of tap positions based on the center of each non-discarded tap position cluster.

4. The method of claim 3, wherein identifying shoulder tap positions comprises identifying two tap positions to the left and two tap positions to the right of each tap position center.

5. The method of claim 4, wherein the threshold number of tap positions is two.

6. The method of claim 1,
wherein the first chip rate is chipx1, and
wherein the higher chip rate channel estimates have a rate of chipx8.

7. The method of claim 1, wherein the enhanced logic can include one or both of tapwise minimum mean square error (MMSE) and temporal correlation.

8. The method of claim 1, further comprising reconstructing the signal by sampling the second set of tap positions at a third chip rate, wherein the third chip rate is twice the first chip rate.

9. The method of claim 1, wherein applying matching pursuit comprises:
identifying a set of potential tap positions based on the first set of tap positions; and
removing duplicate tap positions from the set of potential tap positions to create the second set of tap positions using a merge protection process.

10. The method of claim 1, further comprising:
determining an amplitude associated with each of the tap positions included in the third set of tap positions;
combining the third set of tap positions with the determined amplitudes to create a reconstructed signal; and
sampling the reconstructed signal according to a reduced chip rate.

11. The method of claim 1, further comprising:
determining a number of cells associated with the channel estimation; and
repeating the actions of claim 1 for each cell.

12. The method of claim 11, further comprising repeating the actions of claim 11 for a number of iterations.

13. The method of claim 12, wherein the number of iterations is five.

14. An apparatus for channel estimation, comprising:
a processor;
a memory in electronic communication with the processor, wherein the memory stores instructions executable by the processor to:
determine two streams corresponding to odd and even samples of a received signal that is sampled at a first chip rate;
perform least squares successive interference cancellation on each of the two streams to obtain odd and even raw channel estimates;
interlace the odd and even raw channel estimates to obtain interlaced channel estimates;
interpolate additional samples in the interlaced channel estimates to create higher chip rate channel estimates;
identify a first set of tap positions based on the higher chip rate channel estimates;
apply matching pursuit to the first set of tap positions to identify a second set of tap positions, wherein the second set of tap positions includes fewer tap positions than the first set of tap positions; and
determine a third set of tap positions by clustering each tap position included in the second set of tap positions.

15. The apparatus of claim 14, wherein the instructions are executable by the processor to:
estimate an amplitude of a channel at the third set of tap positions; and
reconstruct the received signal based on the third set of tap positions.

16. The apparatus of claim 14, wherein the instructions are executable by the processor to determine the third set of tap positions by:
identifying shoulder tap positions for each tap position in the second set of tap positions to create tap position clusters, wherein a tap position cluster is centered on the tap position in the second set of tap positions and has a range from the lowest identified shoulder tap position to the highest identified shoulder tap position;
determining how many tap positions included in the second set of tap positions fall into each tap position cluster;
discarding tap position clusters that include fewer than a threshold number of tap positions; and
creating the third set of tap positions based on the center of each non-discarded tap position cluster.

17. The apparatus of claim 16, wherein the instructions are executable by the processor to identify shoulder tap positions by identifying two tap positions to the left and two tap positions to the right of each tap position center.

18. The apparatus of claim 17, wherein the threshold number of tap positions is two.

19. The apparatus of claim 18, wherein the threshold number of tap positions is two.

20. A non-transitory computer-readable medium storing computer executable code, comprising:
code for determining two streams corresponding to odd and even samples of a received signal that is sampled at a first chip rate;
code for performing least squares successive interference cancellation on each of the two streams to obtain odd and even raw channel estimates;
code for interlacing the odd and even raw channel estimates to obtain interlaced channel estimates;
code for interpolating additional samples in the interlaced channel estimates to create higher chip rate channel estimates;
code for identifying a first set of tap positions based on the higher chip rate channel estimates;
code for applying matching pursuit to the first set of tap positions to identify a second set of tap positions, wherein the second set of tap positions includes fewer tap positions than the first set of tap positions; and
code for determining a third set of tap positions by clustering each tap position included in the second set of tap positions.
